(19) United States
(12) Patent Application Publication
(10) Pub. No.: US 2013/0038726 A1
(43) Pub. Date: Feb. 14, 2013

(54) ELECTRONIC APPARATUS AND METHOD FOR PROVIDING STEREO SOUND

(71) Applicant: Jin-hyong Kim, Yongin-si (KR)

(72) Inventor: Jin-hyong Kim, Yongin-si (KR)

(73) Assignee: Samsung Electronics Co., Ltd, Suwon-si (KR)

(21) Appl. No.: 13/454,329

(22) Filed: Apr. 24, 2012

(30) Foreign Application Priority Data
Aug. 9, 2011 (KR) 10-2011-0079106

(51) Int. Cl. H04N 7/18; H04R 5/02

(52) U.S. Cl. 348/143; 381/305; 348/E07.085

(57) ABSTRACT

An electronic apparatus is provided. The electronic apparatus includes a sensor to sense an orientation of the electronic apparatus, an audio processor to divide a stereo audio signal into a left audio signal and a right audio signal, a plurality of speakers disposed at separate locations on a main body of the electronic apparatus to output the left audio signal and the right audio signal, a switching unit to output the left audio signal and the right audio signal from the audio processor to the plurality of speakers, and a controller to control the switching unit to switch the output of the left audio signal and the right audio signal between the plurality of speakers based on a change in the orientation of the electronic apparatus.

### CROSS-REFERENCE TO RELATED APPLICATIONS

This application claims the benefit of priority under 35 U.S.C. §119 to Korean Patent Application No. 10-2011-0079106, filed on Aug. 9, 2011, in the Korean Intellectual Property Office, the disclosure of which is incorporated herein by reference in its entirety.

### BACKGROUND OF THE INVENTION

1. Field of the Invention

The present general inventive concept generally relates to an electronic apparatus and a method for providing a stereo sound, and more particularly, to an electronic apparatus and a method for providing a stereo sound which can provide a stereo sound of proper directionality even if a location of a speaker is changed due to rotation of the electronic apparatus.

2. Description of the Related Art

A tablet computer refers to a computer that mounts a flat touch screen thereon and uses a stylus or digital pen or finger rather than a keyboard or a mouse as an input device. Users may use the tablet computer on their hands like a personal digital assistant (PDA) and may easily use the tablet computer in a desired orientation by rotating it.

A related-art tablet computer outputs all sounds through a single speaker unit without discriminating left and right channels, and thus has a problem in that it cannot provide a stereo sound for the user.

Also, even if two speakers are provided, a stereo sound of proper directionality may not be provided for the user when the locations of the speakers are changed due to rotation of the tablet computer.

### SUMMARY OF THE INVENTION

The present general inventive concept provides an electronic apparatus and a method for providing a stereo sound, which can provide a stereo sound of proper directionality, even if a location of a speaker is changed due to rotation of the electronic apparatus.

Additional features and utilities of the present general inventive concept will be set forth in part in the description which follows and, in part, will be obvious from the description, or may be learned by practice of the general inventive concept.

The foregoing and/or other features and utilities of the present general inventive concept may be realized by an electronic apparatus including a sensor to sense an orientation of the electronic apparatus, an audio processor to divide a stereo audio signal into a left audio signal and a right audio signal, a plurality of speakers disposed at separate locations on a main body of the electronic apparatus to output the left audio signal and the right audio signal, a switching unit to output the left audio signal and the right audio signal from the audio processor to the plurality of speakers, and a controller to control the switching unit to switch the output of the left audio signal and the right audio signal between the plurality of speakers based on a change in the orientation of the electronic apparatus.

The plurality of speakers may include a first speaker and a second speaker disposed in opposite corners on the main body of the electronic apparatus, wherein the controller controls one of the first and the second speakers that is disposed on a left side of the electronic apparatus according to the orientation of the electronic apparatus to output the left audio signal and the other of the first and the second speakers that is disposed on a right side of the electronic apparatus according to the orientation of the electronic apparatus to output the right audio signal.

The audio processor may further divide the stereo audio signal into a sub-woofer audio signal.

The plurality of speakers may include a first speaker, a second speaker, and a third speaker disposed in three corners on the main body of the electronic apparatus, wherein the controller controls one of the first through third speakers that is disposed on a left side of the apparatus according to the orientation of the electronic apparatus to output the left audio signal, one of the first through third speakers that is disposed on a right side of the electronic apparatus according to the orientation of the electronic apparatus to output the right audio signal, and the remaining speaker of the first through third speakers to output the sub-woofer audio signal.

The plurality of speakers may include a first speaker, a second speaker, a third speaker, and a fourth speaker disposed in four corners on the main body of the electronic apparatus, wherein the controller controls two of the first through the fourth speakers that are disposed on a left side of the electronic apparatus according to the orientation of the electronic apparatus to output the left audio signal and two speakers of the first through fourth speakers that are disposed on a right side of the electronic apparatus according to the orientation of the electronic apparatus to output the right audio signal.

The plurality of speakers may include a first speaker disposed on a left side of the main body of the electronic apparatus, and a second speaker disposed on a right side of the main body of the electronic apparatus, wherein, if the orientation of the electronic apparatus is a first landscape orientation with reference to a user, the controller controls the first speaker to output the left audio signal and the second speaker to output the right audio signal, and, if the orientation of the electronic apparatus is a second landscape orientation which is rotated by 180° from the first landscape orientation, the controller controls the first speaker to output the right audio signal and the second speaker to output the left audio signal.

The electronic apparatus may include a user interface to display a user interface window, wherein the sensor senses the orientation of the electronic apparatus according to a display direction of the user interface window on the main body of the electronic apparatus.

The sensor may sense the orientation of the electronic apparatus using at least one of a geomagnetic sensor, a gyro sensor, an acceleration sensor, and a gyro/acceleration sensor.

Features and/or utilities of the present general inventive concept may also be realized by a method of providing a stereo sound of an electronic apparatus, the method including sensing an orientation of the electronic apparatus, dividing a stereo audio signal into a left audio signal and a right audio signal, outputting the left audio signal and the right audio signal to a plurality of speakers, and controlling the outputting of the left audio signal and the right audio signal by switching the output of the left audio signal and the right audio signal between the plurality of speakers based on a change in the orientation of the electronic apparatus.

The plurality of speakers may include a first speaker and a second speaker disposed in opposite corners on the main body of the electronic apparatus, wherein the controlling the outputting of the left audio signal and the right audio signal comprises controlling one of the first and the second speakers that is disposed on a left side of the electronic apparatus according to the orientation of the electronic apparatus to output the left audio signal and the other of the first and second speakers that is disposed on a right side of the electronic apparatus according to the orientation of the electronic apparatus to output the right audio signal.

The dividing may include further dividing the stereo audio signal into a sub-woofer audio signal.

The plurality of speakers may include a first speaker, a second speaker, and a third speaker disposed in three corners on the main body of the electronic apparatus, wherein the controlling the outputting of the left audio signal and the right audio signal comprises controlling one of the first through third speakers that is disposed on a left side of the apparatus according to the orientation of the electronic apparatus to output the left audio signal, one of the first through third speakers that is disposed on a right side of the electronic apparatus according to the orientation of the electronic apparatus to output the right audio signal, and the remaining speaker of the first through third speakers to output the sub-woofer audio signal.

The plurality of speakers may include a first speaker, a second speaker, a third speaker, and a fourth speaker disposed in four corners on the main body of the electronic apparatus, wherein the controlling the outputting of the left audio signal and the right audio signal comprises controlling two speakers of the first through fourth speakers that are disposed on a left side of the electronic apparatus according to the orientation of the electronic apparatus to output the left audio signal and two speakers of the first through fourth speakers that are disposed on a right side of the electronic apparatus to output the right audio signal.

The plurality of speakers may include a first speaker disposed on a left side of the main body of the electronic apparatus, and a second speaker disposed on a right side of the main body of the electronic apparatus, wherein controlling the outputting of the left audio signal and the right audio signal comprises, if the orientation of the electronic apparatus is a first landscape orientation with reference to a user, controlling the first speaker to output the left audio signal and the second speaker to output the right audio signal, and if the orientation of the electronic apparatus is a second landscape orientation which is rotated by 180° from the first landscape orientation, controlling the first speaker to output the right audio signal and the second speaker to output the left audio signal.

The method may further include displaying a user interface window, wherein the sensing comprises sensing the orientation of the electronic apparatus according to a display direction of the user interface window on the main body of the electronic apparatus.

The sensing may include sensing the orientation of the electronic apparatus using at least one of a geomagnetic sensor, a gyro sensor, an acceleration sensor, and a gyro/acceleration sensor.

Features and/or utilities of the present general inventive concept may also be realized by a non-transitory computer readable recording medium comprising a program to execute a method of providing a stereo sound, the method including sensing an orientation of an electronic apparatus, dividing a stereo audio signal into a left audio signal and a right audio signal, outputting the left audio signal and the right audio signal to a plurality of speakers, and controlling the outputting of the left audio signal and the right audio signal by switching the output of the left audio signal and the right audio signal between the plurality of signals based on a change in the orientation of the electronic apparatus.

The electronic apparatus may be at least one of a tablet computer and a mobile phone.

Features and/or utilities of the present general inventive concept may also be realized by an electronic apparatus including a sensor to sense an orientation of the electronic apparatus with respect to a user, a plurality of speakers disposed at different locations on the electronic apparatus, a switching unit to output a left audio signal and a right audio signal to the plurality of speakers, and a controller to control the switching unit to switch the output of the left and right audio signals to the plurality of speakers when the orientation of the electronic apparatus changes such that the switching unit outputs the left audio signal to one or more of the plurality of speakers oriented on a left side of the electronic apparatus with respect to the user and outputs the right audio signal to one or more of the plurality of speakers oriented on a right side of the electronic apparatus with respect to the user.

Features and/or utilities of the present general inventive concept may also be realized by an electronic apparatus including a sensor to sense an orientation of the electronic apparatus with respect to a user, a plurality of speakers disposed at different locations on the electronic apparatus, an audio processor to process an audio signal and to output processed audio signals to each of the plurality of speakers, and a controller to determine a location of each of the plurality of speakers with respect to the user based on the sensed orientation and to control the audio processor to process the audio signal based on the determined locations of each of the plurality of speakers.

The audio processor may process the audio signal into virtual surround sound signals based on the determined locations of each of the plurality of speakers.

The controller may determine the location of each of the plurality of speakers with respect to a head of the user.

The electronic apparatus may further include a camera disposed on a front side of the electronic apparatus, and an image processor to image process images captured by the camera.

The camera may capture an image of the user, the image processor processes the captured image to locate the user in the captured image, and the controller determines the location of each of the plurality of speakers with respect to the user by using the processed image.

The image processor may process the captured image to locate a head of the use in the captured image and the controller determines the location of each of the plurality of speakers with respect to the head of the user.

The image processor may use facial recognition processing to locate the head of the user in the captured image.

Features and/or utilities of the present general inventive concept may also be realized by an electronic apparatus including a camera disposed on a front side of the electronic apparatus to capture an image of a user, an image processor to process the captured image to locate the user in the captured image; a plurality of speakers disposed at different locations on the electronic apparatus, an audio processor to process an audio signal and to output processed audio signals to each of the plurality of speakers, and a controller to determine a location of each of the plurality of speakers with respect to the user by using the processed image and to control the audio processor to process the audio signal based on the determined locations of each of the plurality of speakers.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating an electronic apparatus according to an exemplary embodiment;

FIG. 2 is a block diagram illustrating an audio output unit of FIG. 1 in detail;

FIGS. 3A to 4 are views illustrating an audio output unit according to a first exemplary embodiment;

FIG. 5 is a view to explain an operation of the audio output unit according to the first exemplary embodiment;

FIGS. 6 and 7 are views illustrating an audio output unit according to a second exemplary embodiment;

FIG. 8 is a view to explain an operation of the audio output unit according to the second exemplary embodiment;

FIGS. 9 and 10 are views illustrating an audio output unit according to a third exemplary embodiment;

FIG. 11 is a view to explain an operation of the audio output unit according to the third exemplary embodiment;

FIG. 12 is a view illustrating an audio output unit according to a fourth exemplary embodiment;

FIG. 13 is a view to explain an operation of the audio output unit according to the fourth exemplary embodiment;

FIG. 14 is a view illustrating an example of an HD audio codec;

FIG. 15 is a view to explain a configuration of a window;

FIG. 16 is a flowchart illustrating a method for providing a stereo sound according to an exemplary embodiment;

FIG. 17 illustrates an electronic apparatus according to another embodiment of the present general inventive concept;

FIG. 18 illustrates a view of the electronic apparatus illustrated in FIG. 17;

FIG. 19 illustrates a user and the electronic apparatus illustrated in FIG. 17; and

FIG. 20 illustrates images of a user captured by the electronic apparatus illustrated

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept while referring to the figures.

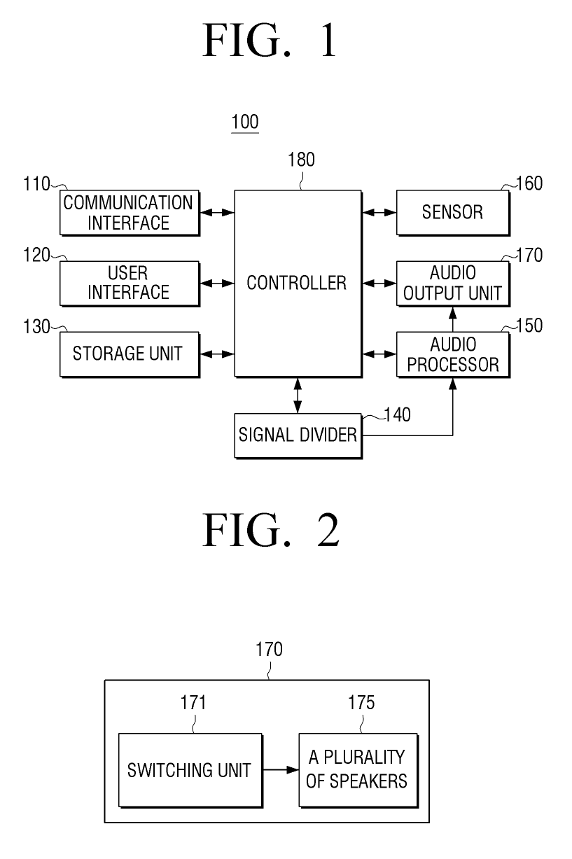

FIG. 1 is a block diagram illustrating an electronic apparatus according to an exemplary embodiment.

Referring to FIG. 1, an electronic apparatus 100 according to an exemplary embodiment includes a communication interface 110, a user interface 120, a storage unit 130, a signal divider 140, an audio processor 150, a sensor 160, an audio output unit 170, and a controller 180. The electronic apparatus 100 may be, for example, a tablet computer, an MPEG audio layer 3 (MP3) player, a portable multimedia player (PMP), or a mobile phone, in which a user interface window can be rotated by rotation of a main body.

The communication interface 110 may connect to at least one external host apparatus or the Internet, and may communicate in a wired or wireless manner. The communication interface 110 may receive a content having a stereo sound from an external apparatus. The content recited herein may be a sound or radio content including only audio signals, a moving picture content including audio signals and video signals, or a game content.

The user interface 120 includes a plurality of function keys through which a user sets or selects various functions supported by the electronic apparatus 100, and may display diverse information provided by the electronic apparatus 100. The user interface 120 may be realized by a device implementing input and output simultaneously such as a touch pad, or may further include a separate input device such as a mouse or a keyboard.

The user interface 120 displays a user interface window to receive selection of a content to be reproduced from the user. The user may select the content to be reproduced through the displayed user interface window.

The user interface 120 may display an image corresponding to the content selected by the user. The user interface 120 may display the user interface window that is rotated in response to rotation of the electronic apparatus 100. For example, if the electronic apparatus 100 is rotated to the left by 90°, the user interface 120 may display the user interface window that is rotated to the right by 90° on the main body of the electronic apparatus 100. Also, if the electronic apparatus 100 is rotated to the right by 90°, the user interface 120 may display the user interface window that is rotated to the left by 90° on the main body of the electronic apparatus 100. If the electronic apparatus 100 is rotated to the right or the left by 180°, the user interface 120 may display the user interface window that is rotated by 180° on the main body of the electronic apparatus 100.

The storage unit 130 stores various contents. More specifically, the storage unit 130 may store the contents received through the communication unit 110. The storage unit 130 may be realized, for example, by a hard disk, a non-volatile memory, or a volatile memory.

The signal divider 140 divides a broadcast signal or a content into an audio signal and a video signal. The signal divider 140 transmits the divided video signal to the user interface 120, while transmitting the divided audio signal to the audio processor 150.

The audio processor 150 performs signal-processing such as audio decoding with respect to the audio signal input from the signal divider 140. Also, the audio processor 150 divides the signal-processed audio signal into a left audio signal and a right audio signal, and transmits the left and the right audio signals to the audio output unit 170.

The audio processor 150 may extract a sub-woofer audio signal from the signal-processed audio signal. The sub-woofer audio signal is an audio signal of a low audio frequency (for example, from 20 hz to 1.5 KHz) which is commonly included in the left audio signal and the right audio signal.

The sensor 160 senses a rotational state of the electronic apparatus 100. More specifically, the sensor 160 senses the rotational state of the electronic apparatus 100 using a geomagnetic sensor, a gyro sensor, an acceleration sensor, or a gyro/acceleration sensor. Also, the sensor 160 may sense the rotational state according to a display direction of the user interface window displayed on the user interface 120. For example, if the user interface window rotated to the right by 90° on the main body of the electronic apparatus 100 is displayed, the sensor 160 may sense that the electronic apparatus 100 has been rotated to the left by 90°.

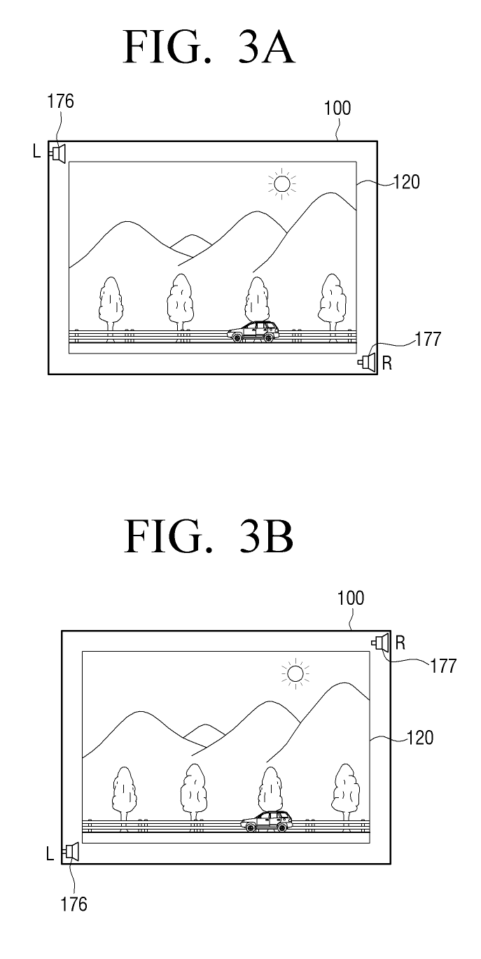

The audio output unit 170 receives the audio signals output from the audio processor 150, and outputs the audio signal corresponding to each speaker to a plurality of speakers. Detailed configuration and operation of the audio output unit 170 will be described below with reference to FIG. 2.

The controller 180 controls the elements included in the electronic apparatus 100. More specifically, if a location of each speaker is changed due to the rotation of the electronic apparatus 100, the controller 180 may control the audio output unit 170 to output the audio signals corresponding to the changed locations of the speakers through the plurality of speakers.

As described above, the electronic apparatus 100 according to the exemplary embodiment can provide the stereo sound of proper directionality, even if the locations of the speakers are changed due to the rotation of the electronic apparatus 100.

FIG. 2 is a block diagram illustrating the audio output unit of FIG. 1 in detail.

Referring to FIG. 2, the audio output unit 170 includes a switching unit 171 and a plurality of speakers 175.

The switching unit 171 provides the output signals of the audio processor 150 to the plurality of speakers 175. More specifically, the switching unit 171 includes a plurality of switching elements, and provides the left audio signal to the speaker disposed on the left of the electronic apparatus 100 and provides the right audio signal to the speaker disposed on the right of the electronic apparatus 100. Also, if the switching unit 171 further receives the sub-woofer audio signal from the audio processor 150, the switching unit 171 provides the left audio signal to the left speaker of the two speakers which are aligned with each other according to the rotational state of the electronic apparatus 100, provides the right audio signal to the right speaker, and provides the sub-woofer audio signal to the remaining speaker.

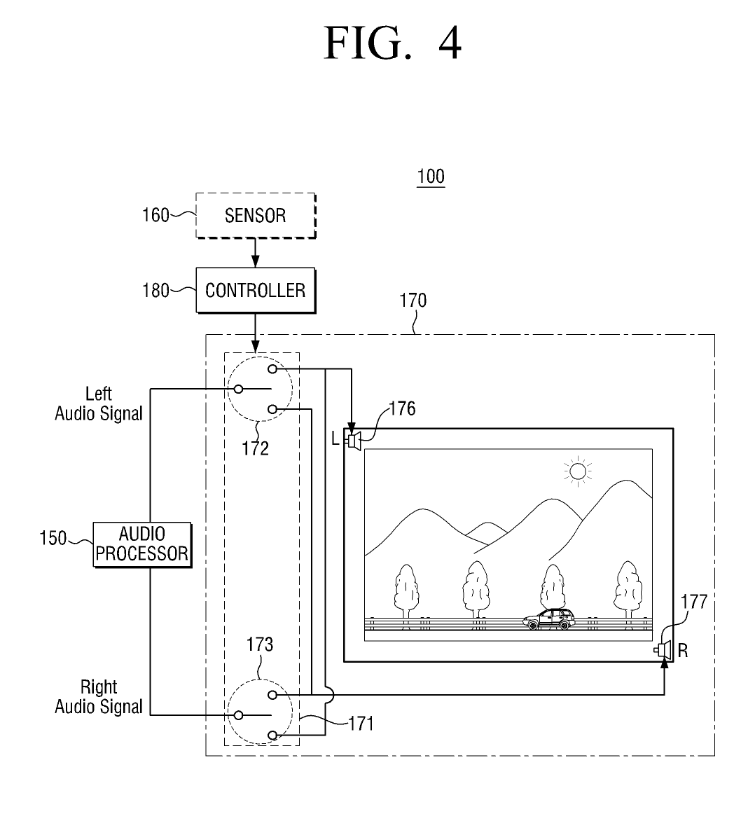

The speakers 175 output a sound according to the input audio signal. The number of speakers and the locations of the speakers may be diversely set. Hereinafter, operation of the audio output unit 170 according to the number of speakers and the arrangement of the speakers will be explained with reference to FIGS. 3A to 13.

FIGS. 3A to 4 are views illustrating the electronic apparatus 100 according to a first exemplary embodiment.

The electronic apparatus 100 according to the first embodiment includes a user interface 120 and a first speaker 176 and a second speaker 177 which are disposed in two opposite corners on the main body of the electronic apparatus 100. The first speaker 176 and second speaker 177 are included in the plurality of speakers 175 included in the audio output unit 170.

Referring to FIG. 3A, the first speaker 176 is disposed on an upper left portion on the main body of the electronic apparatus 100, and the second speaker 177 is disposed on a lower right portion on the main body of the electronic apparatus 100.

Referring to FIG. 3B, the first speaker 176 is disposed on a lower left portion on the main body of the electronic apparatus 100, and the second speaker 177 is disposed on an upper right portion on the main body of the electronic apparatus 100.

Hereinafter, the operation of the audio output unit 170, if the first speaker and the second speaker are disposed on the electronic apparatus 100 as shown in FIG. 3A, will be explained with reference to FIG. 4. The following explanation is applied to the arrangement of the first speaker 176 and the second speaker 177 as illustrated in FIG. 3A, but may be applied in a modified form to the arrangement of the first speaker 176 and the second speaker 177 as illustrated in FIG. 3B.

Referring to FIG. 4, the audio processor 150 provides a left audio signal and a right audio signal to the switching unit 171.

The sensor 160 provides a sensed rotational state of the electronic apparatus 100 to the controller 180.

The switching unit 171 includes two switching elements 172 and 173 and provides the left audio signal and the right audio signal to the corresponding speakers 176 and 177 under control of the controller 180.

The controller 180 controls connecting states of the two switching elements 171 and 173 according to the rotational state of the electronic apparatus 100. More specifically, if an orientation of the electronic apparatus 100 is a first landscape orientation (0°) with reference to the user or a first portrait orientation (rotated to the left by 90° from the first landscape orientation), the controller 180 may control the switching unit 171 to provide the left audio signal to the first speaker 176 and provide the right audio signal to the second speaker 177.

If the orientation of the electronic apparatus 100 is a second portrait orientation (rotated to the right by 90° or rotated to the left by 270° from the first landscape orientation) or a second landscape orientation (rotated by 180° from the first landscape orientation), the controller 180 may control the switching unit 171 to provide the right audio signal to the first speaker 176 and provide the left audio signal to the second speaker 177.

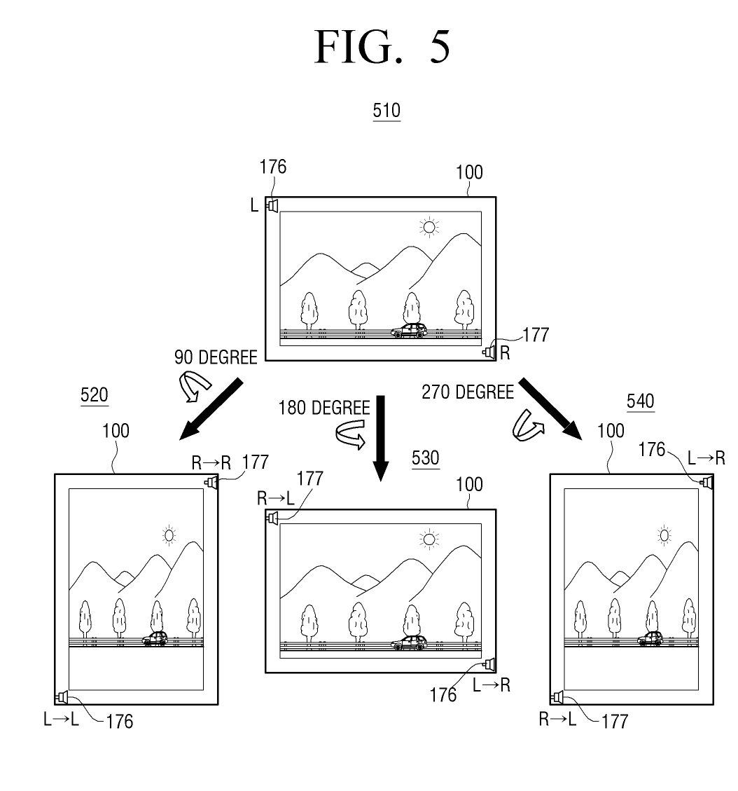

FIG. 5 is a view to explain the operation of the audio output unit 170 according to the first exemplary embodiment.

FIG. 5 illustrates the electronic apparatus 100 oriented in a first landscape orientation 510, a first portrait orientation 520, a second landscape orientation 530, and a second portrait orientation 540. The first portrait orientation 520 is reached by rotating the electronic apparatus 100 90° to the left from the first landscape orientation 510. The second landscape orientation 530 is reached by rotating the electronic apparatus 100 180° to the right or left from the first landscape orientation 510. The second portrait orientation 540 is reached by rotating the electronic apparatus 100 by 270° to the left or 90° to the right from the first landscape orientation 510.

Referring to FIG. 5, if the electronic apparatus 100 is in the first landscape orientation 510, the first speaker 176 outputs a sound using the left audio signal and the second speaker 177 outputs a sound using the right audio signal.

If the electronic apparatus 100 is in the first landscape orientation 520, the first speaker 176 outputs the sound using the left audio signal and the second speaker 177 outputs the sound using the right audio signal.

If the electronic apparatus 100 is in the second landscape orientation 530, the first speaker 176 outputs the sound using the right audio signal and the second speaker 177 outputs the sound using the left audio signal.

If the electronic apparatus 100 is in the second portrait orientation 540, the first speaker 176 outputs the sound using the right audio signal and the second speaker 177 outputs the sound using the left audio signal.

According the first exemplary embodiment described above, if the electronic apparatus 100 is rotated to the left by 90°, 180°, or 270°, the electronic apparatus 100 provides the sound corresponding to the left audio signal using the speaker disposed on the left of the user and provides the sound corresponding to the right audio signal using the speaker disposed on the right of the user, so that the stereo sound of exact directionality can be provided for the user.

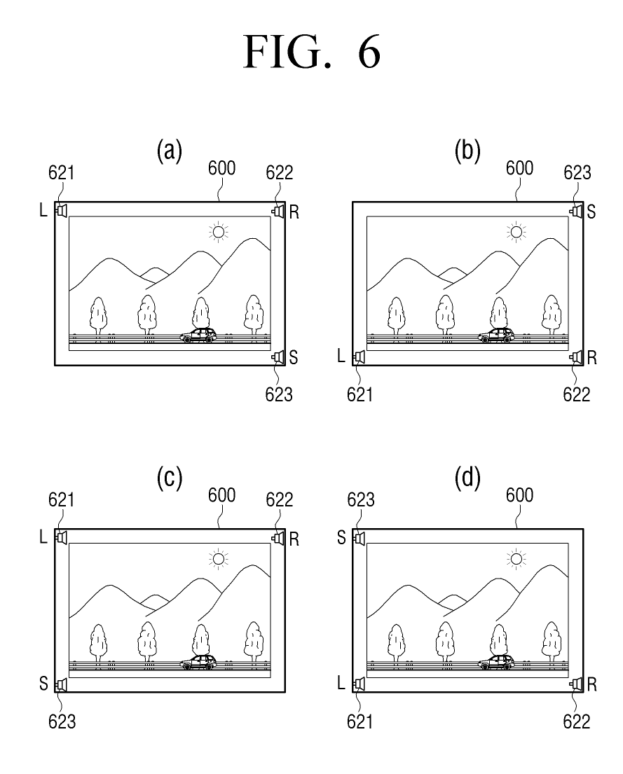

FIGS. 6 and 7 are views illustrating an electronic apparatus 600 according to a second exemplary embodiment.

The electronic apparatus 600 according to the second exemplary embodiment includes a first speaker 621, a second speaker 622, and a third speaker 623 which are disposed in three corners on the main body of the electronic apparatus 600.

Specifically, referring to (a) of FIG. 6, the first speaker 621 is disposed on an upper left portion on the main body of the electronic apparatus 600, the second speaker 622 is disposed on an upper right portion on the main body of the electronic apparatus 600, and the third speaker 623 is disposed on a lower right portion on the main body of the electronic apparatus 600.

Referring to (b) of FIG. 6, the first speaker 621 is disposed on a lower left portion on the main body of the electronic apparatus 600, the second speaker 622 is disposed on the lower right portion on the main body of the electronic apparatus 600, and the third speaker 623 is disposed on the upper right portion on the main body of the electronic apparatus 600.

Referring to (c) of FIG. 6, the first speaker 621 is disposed on the upper left portion on the main body of the electronic apparatus 600, the second speaker 622 is disposed on the upper right portion on the main body of the electronic apparatus 600, and the third speaker 623 is disposed on the lower left portion on the main body of the electronic apparatus 600.

Referring to (d) of FIG. 6, the first speaker 621 is disposed on the lower left portion on the main body of the electronic apparatus 600, the second speaker 622 is disposed on the lower right portion on the main body of the electronic apparatus 600, and the third speaker 623 is disposed on the upper left portion on the main body of the electronic apparatus 600.

Hereinafter, an operation of the audio output unit 770, if the first through the third speakers 621, 622, and 623 are disposed on the electronic apparatus 600 as shown in (a) of FIG. 6, will be explained with reference to FIG. 7. The following explanation is applied to the electronic apparatus 600 as shown in (a) of FIG. 6, but may be applied in a modified form to the electronic apparatus 600 as shown in (b) to (d) of FIG. 6.

Referring to FIG. 7, the audio processor 150 provides a left audio signal, a right audio signal, and a sub-woofer audio signal to a switching unit 710.

The sensor 160 senses an orientation of the electronic apparatus 100 and provides the sensed orientation of the electronic apparatus 600 to the controller 180.

The switching unit 710 includes three switching elements 711, 712, and 713, and provides the left audio signal, the right audio signal, and the sub-woofer audio signal to the corresponding speakers 621, 622, and 623 under control of the controller 180.

The controller 180 may control the three switching elements 711, 712, and 713 to output the left audio signal to the speaker that is disposed on the left side of the electronic apparatus 600 of the two speakers which are aligned with each other according to the orientation of the electronic apparatus 600 and output the right audio signal to the speaker that is disposed on the right side of the electronic apparatus 600, and output the sub-woofer audio signal to the remaining speaker.

More specifically, if an orientation of the electronic apparatus 600 is a first landscape orientation (0°) with reference to the user, the controller 180 may control the switching unit 710 to provide the left audio signal to the first speaker 621, provide the right audio signal to the second speaker 622, and provide the sub-woofer audio signal to the third speaker 623.

If the orientation of the electronic apparatus 600 is a first portrait orientation (rotated to the left by 90° from the first landscape orientation) with reference to the user, the controller 180 may control the switching unit 710 to provide the sub-woofer audio signal to the first speaker 621, provide the left audio signal to the second speaker 622, and provide the right audio signal to the third speaker 623.

If the orientation of the electronic apparatus 600 is a second landscape orientation (rotated by 180° from the first landscape orientation) with reference to the user, the controller 180 may control the switching unit 710 to provide the right audio signal to the first speaker 621, provide the left audio signal to the second speaker 622, and provide the sub-woofer audio signal to the third speaker 623.

If the orientation of the electronic apparatus 600 is a second portrait orientation (rotated to the right by 90° or rotated to the left by 270° from the first landscape orientation), the controller 180 may control the switching unit 710 to provide the sub-woofer audio signal to the first speaker 621, provide the right audio signal to the second speaker 622, and provide the left audio signal to the third speaker 623.

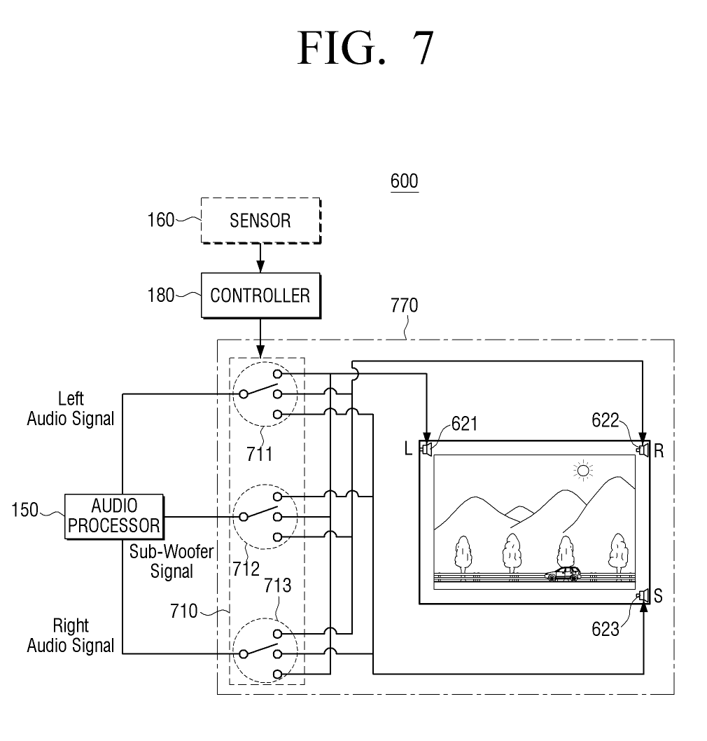

FIG. 8 is a view to explain the operation of the audio output unit according to the second exemplary embodiment.

Referring to FIG. 8, if the electronic apparatus 600 is in the first landscape orientation 810, the first speaker 621 outputs a sound using the left audio signal, the second speaker 622 outputs a sound using the right audio signal, and the third speaker 623 outputs a sound using the sub-woofer audio signal.

If the electronic apparatus 600 is in the first portrait orientation 820, the first speaker 621 outputs the sound using the sub-woofer audio signal, the second speaker 622 outputs the sound using the left audio signal, and the third speaker 623 outputs the sound using the right audio signal.

If the electronic apparatus 600 is in the second landscape orientation 830, the first speaker 621 outputs the sound using the right audio signal, the second speaker 622 outputs the sound using the left audio signal, and the third speaker 623 outputs the sound using the sub-woofer audio signal.

If the electronic apparatus 600 is in the second portrait orientation 840, the first speaker 621 outputs the sound using the sub-woofer audio signal, the second speaker 622 outputs the sound using the right audio signal, and the third speaker 623 outputs the sound using the left audio signal.

According to the second exemplary embodiment described above, if the electronic apparatus 600 is rotated to the left by 90°, 180°, or 270°, the electronic apparatus 100 provides the sound corresponding to the left audio signal using the speaker disposed on the left side of the electronic apparatus 600 with respect to the user and provides the sound corresponding to the right audio signal using the speaker disposed on the right side of the electronic apparatus 600 with respect to the user, so that the stereo sound of proper directionality can be provided for the user. Also, considering that the sub-woofer audio signal is used, the sound of low-pitched tone can be provided for the user.

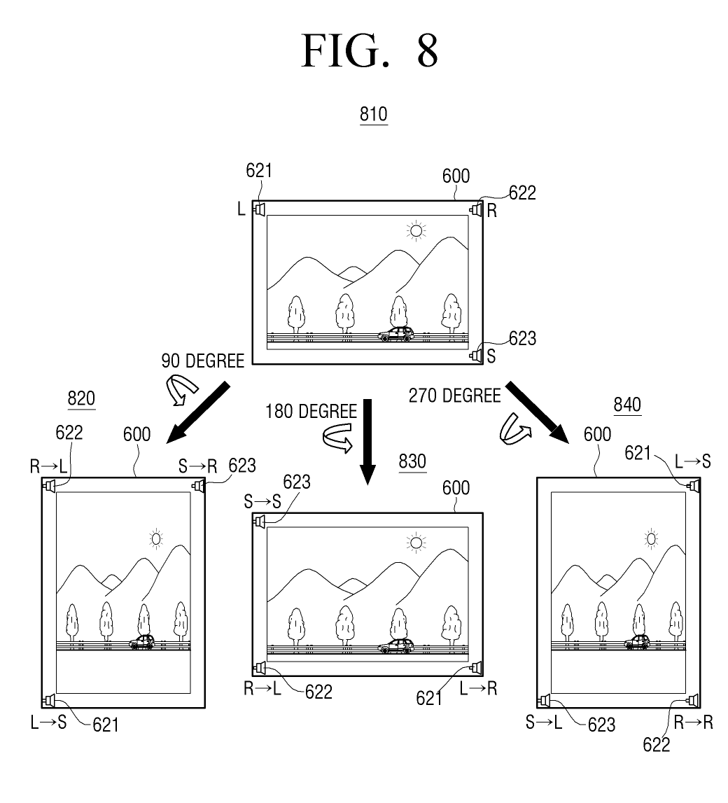

FIGS. 9 and 10 are views illustrating an electronic apparatus 900 according to a third exemplary embodiment.

The audio output unit 1070 according to the third exemplary embodiment includes a first speaker 921, a second speaker 922, a third speaker 923, and a fourth speaker 924 which are disposed in four corners on a main body of an electronic apparatus 900.

More specifically, referring to FIG. 9, the first speaker 921 is disposed on an upper left portion on the main body of the electronic apparatus 900, the second speaker 922 is disposed on an upper right portion on the main body of the electronic apparatus 900, the third speaker 923 is disposed on an lower left portion on the main body of the electronic apparatus 900, and the fourth speaker 924 is disposed on a lower right portion on the main body of the electronic apparatus 900.

Hereinafter, an operation of the audio output unit 1070, if the first through the fourth speakers 921, 922, 923, and 924 are disposed on the electronic apparatus 900 as shown in FIG. 9, will be explained with reference to FIG. 10.

Referring to FIG. 10, the audio processor 150 provides a left audio signal and a right audio signal to a switching unit 1010.

The sensor 160 provides a sensed rotational state of the electronic apparatus 900 to the controller 180.

The switching unit 1010 includes four switching elements 1011, 1012, 1013, and 1014 and provides the left audio signal and the right audio signal to the corresponding speakers 921, 922, 923, and 924 under control of the controller 180.

According to the orientation of the electronic apparatus 900, the controller 180 may control the four switching elements 1011, 1012, 1013, and 1014 to provide the left audio signal to the two of the first through the fourth speakers 921, 922, 923, and 924 that are disposed on the left side of the electronic apparatus 900 with respect to the user, and provide the right audio signal to the two speakers that are disposed on the right side of the electronic apparatus 900 with respect to the user.

More specifically, if an orientation of the electronic apparatus 900 is a first landscape orientation (0°) with reference to the user, the controller 180 may control the switching unit 1010 to provide the left audio signal to the first speaker 921 and the third speaker 923 and provide the right audio signal to the second speaker 922 and the fourth speaker 924.

If the orientation of the electronic apparatus 900 is a first portrait orientation (rotated to the left by 90° from the first landscape orientation) with reference to the user, the controller 180 may control the switching unit 1010 to provide the left audio signal to the first speaker 921 and the second speaker 922 and provide the right audio signal to the third speaker 923 and the fourth speaker 924.

If the orientation of the electronic apparatus 900 is a second landscape orientation (rotated by 180° from the first landscape orientation) with reference to the user, the controller 180 may control the switching unit 1010 to provide the right audio signal to the first speaker 921 and the third speaker 923 and provide the left audio signal to the second speaker 922 and the fourth speaker 924.

If the orientation of the electronic apparatus 900 is a second portrait orientation (rotated to the right by 90° or rotated to the left by 270° from the first landscape orientation), the controller 180 may control the switching unit 1010 to provide the right audio signal to the first speaker 921 and the second speaker 922 and provide the left audio signal to the third speaker 923 and the fourth speaker 924.

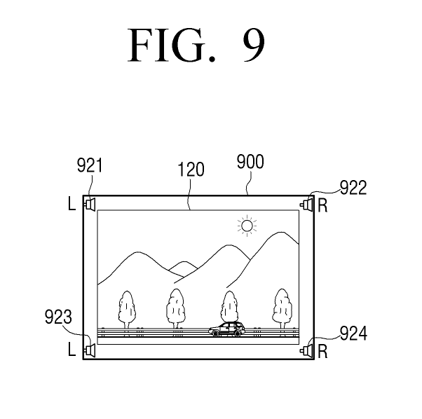

FIG. 11 is a view to explain an operation of the audio output unit 1070 according to the third exemplary embodiment.

Referring to FIG. 11, if the electronic apparatus 900 is in the first landscape orientation 1110, the first speaker 921 and the third speaker 923 output a sound using the left audio signal and the second speaker 922 and the fourth speaker 924 output a sound using the right audio signal.

If the electronic apparatus 900 is in the first portrait orientation 1120, the first speaker 921 and the second speaker 922 output the sound using the left audio signal and the third speaker 923 and the fourth speaker 924 output the sound using the right audio signal.

If the electronic apparatus 900 is in the second landscape orientation 1130, the first speaker 921 and the third speaker 923 output the sound using the right audio signal and the second speaker 922 and the fourth speaker 924 output the sound using the left audio signal.

If the electronic apparatus 900 is in the second portrait orientation 1140, the first speaker 921 and the second speaker 922 output the sound using the right audio signal and the third speaker 922 and the fourth speaker 924 output the sound using the right audio signal.

According to the third exemplary embodiment described above, if the electronic apparatus 900 is rotated to the left by 90°, 180°, or 270°, the electronic apparatus 900 provides the sound corresponding to the left audio signal using the speakers disposed on the left of the user and provides the sound corresponding to the right audio signal using the speakers disposed on the right of the user, so that the stereo sound of exact directionality can be provided for the user.

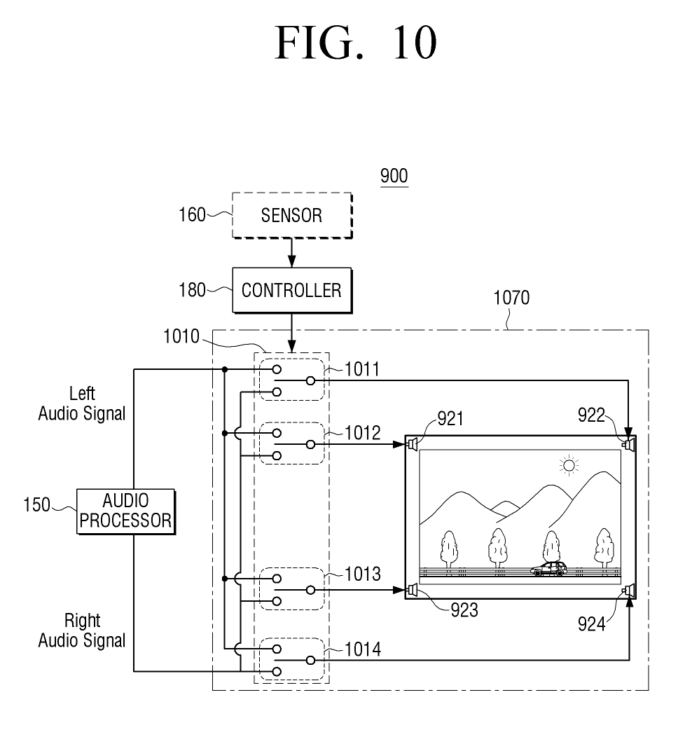

FIG. 12 is a view illustrating an electronic apparatus 1200 according to a fourth exemplary embodiment.

The audio output unit 1270 according to the fourth exemplary embodiment includes a first speaker 1210 and a second speaker 1220 which are disposed on opposite sides on a main body of an electronic apparatus 1200.

More specifically, referring to FIG. 12, the first speaker 1210 is disposed on a left side on the main body of the electronic apparatus 1200 and the second speaker 1220 is disposed on a right side on the main body of the electronic apparatus 1200.

The audio processor 150 provides a left audio signal and a right audio signal to the switching unit 171.

The sensor 160 provides a sensed orientation of the electronic apparatus 1200 to the controller 180.

The switching unit 171 includes two switching elements 172 and 173 and provides the left audio signal and the right audio signal to the corresponding speakers 1210 and 1220 under control of the controller 180.

The controller 180 controls connecting states of the two switching elements 172 and 173 according to the orientation of the electronic apparatus 1200. More specifically, if an orientation of the electronic apparatus 100′″ is a first landscape orientation (0°) with reference to the user, the controller 180 may control the switching unit 171 to provide the left audio signal to the first speaker 1210 and provide the right audio signal to the second speaker 1220.

If the orientation of the electronic apparatus 1200 is a second landscape orientation (rotated by 180° from the first landscape orientation) with reference to the user, the controller 180 may control the switching unit 171 to provide the right audio signal to the first speaker 1210 and provide the left audio signal to the second speaker 1220.

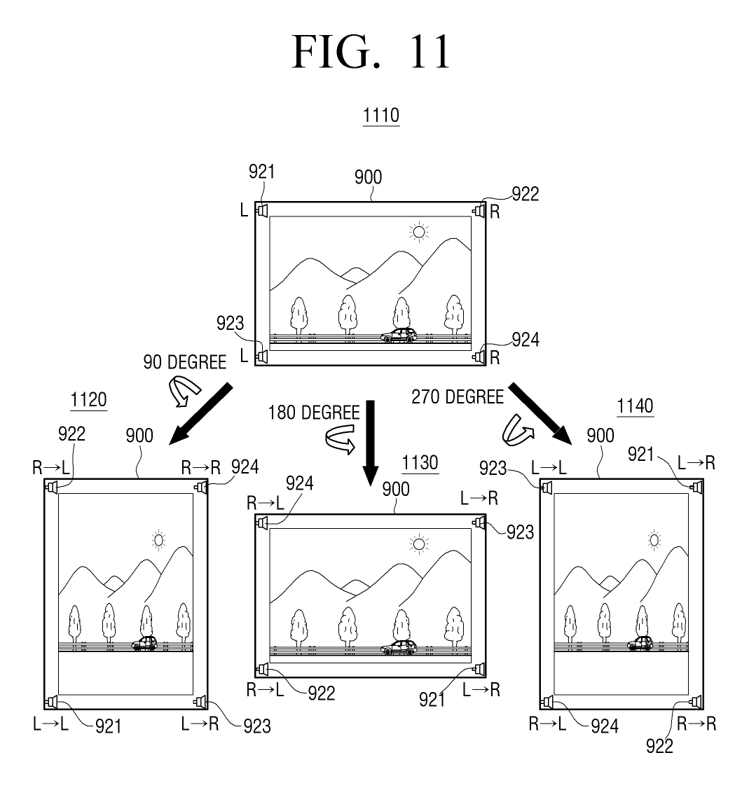

FIG. 13 is a view to explain an operation of the audio output unit 1270 according to the fourth exemplary embodiment.

Referring to FIG. 13, if the electronic apparatus 1200 is in the first landscape orientation 1310, the first speaker 1210 outputs a sound using the left audio signal and the second speaker 1220 outputs a sound using the right audio signal.

If the electronic apparatus 1200 is in the second landscape orientation 1320, the first speaker 1210 outputs the sound using the right audio signal and the second speaker 1220 outputs the sound using the left audio signal.

According to the fourth exemplary embodiment described above, if the electronic apparatus 1200 is rotated by 180°, the electronic apparatus 12000 provides the sound corresponding to the left audio signal using the speaker disposed on the left of the user and provides the sound corresponding to the right audio signal using the speaker disposed on the right of the user, so that the stereo sound of exact directionality can be provided for the user.

Although the plurality of speakers are provided on an upper surface (or a front surface) of the electronic apparatus in the embodiments of FIGS. 2 to 13, the plurality of speakers may be provided on a rear surface (or a lower surface) of the electronic apparatus or may be provided on a side surface of the electronic apparatus.

Also, although the audio signals are provided to the plurality of speakers selectively using the switching element in the embodiments of FIGS. 2 to 13, the above-described operations may be implemented using HD audio codec register setting instead of using the switching element, if the audio processor 150 is an HD audio codec.

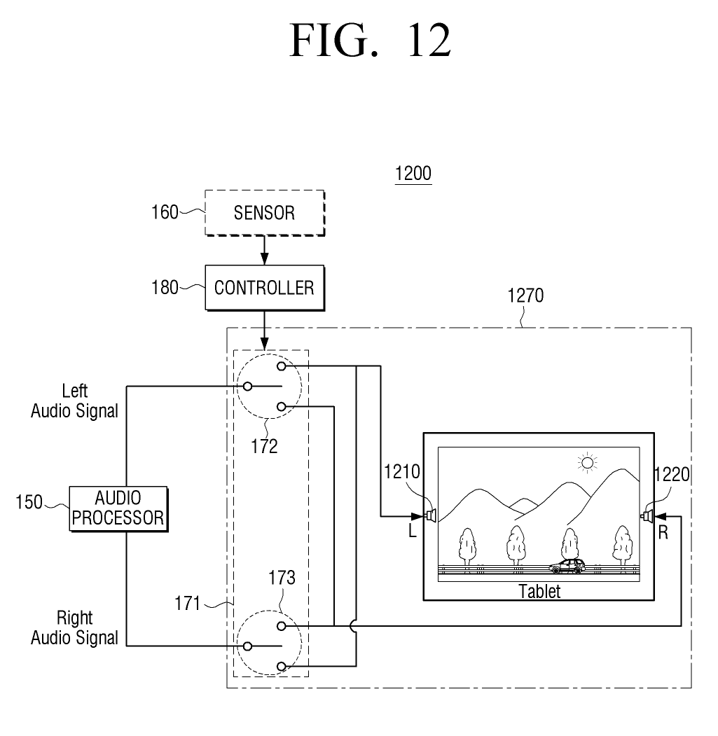

More specifically, the HD audio codec includes an analog input/output unit as shown in FIG. 14 and thus realizes conversion between left and right speakers and a sub-woofer speaker by changing a registry value. For example, if audio pins 43 and 44 are used as a sub-woofer, a value of 0x01012014 may be set in the codec register, and, if audio pins 35 and 36 are used as the left and right speakers, a value of 0x01014010 may be set in the codec register.

After that, if the left and the right speakers are operated as the sub-woofer speaker or if the sub-woofer speaker is used as the left and the right speakers, the codec register value of the audio pins 43 and 44 is changed from 0x010121014 to 0x01016411 and the codec register value of the audio pins 35 and 36 is changed from 0x01014010 to 0x01014410.

If output sources of the left and the right speakers are changed, that is, if a right audio signal is provided to the left speaker and a left audio signal is provided to the right speaker, the outputs of the left and the right speakers are changed by changing a 7^{th} bit of 32 bits of Verb ID F00h and Parameter ID 0ch among the register pins of the audio codec, that is, using an LR swap function.

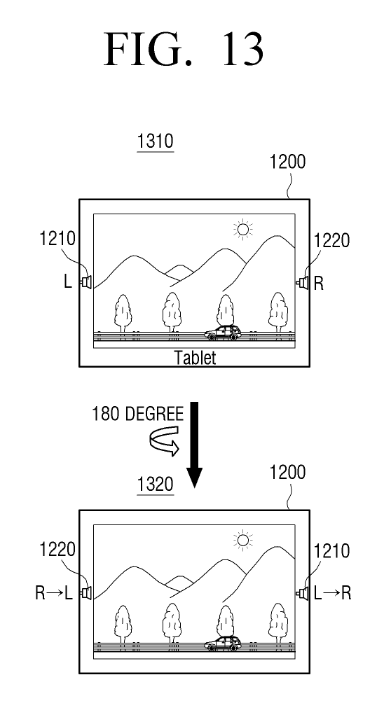

Changing the output location of the left and the right speakers may be realized in a software level. More specifically, if the electronic apparatus 100 is operated with a window operating system as shown in FIG. 15, the output location of the left and the right speaker may be changed by swapping left and right audio data generated by an application using an audio processing object (APO) function, using a memory buffer.

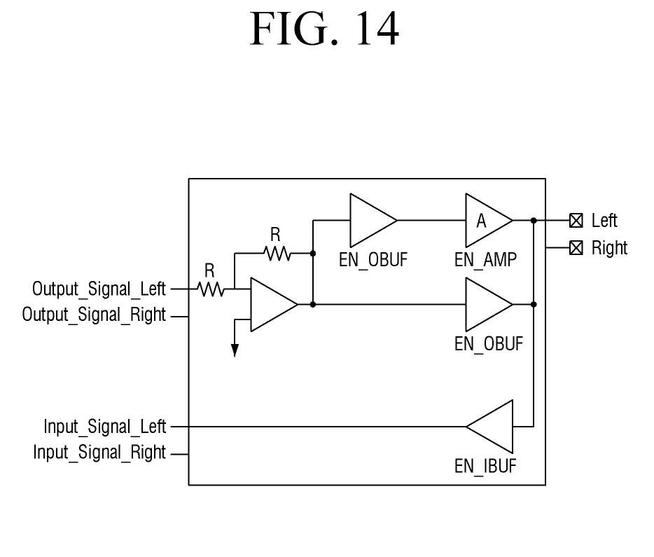

FIG. 16 is a flowchart illustrating a method for providing a stereo sound according to an exemplary embodiment.

Referring to FIG. 16, an orientation of the electronic apparatus is sensed (S1610). More specifically, the orientation of the electronic apparatus may be sensed using a geomagnetic sensor, a gyro sensor, an acceleration sensor, or a gyro/acceleration sensor. In practice, the orientation of the electronic apparatus may be sensed according to a display direction of the user interface window. For example, if the user interface window rotated to the right by 90° on the main body of the electronic apparatus is displayed, the electronic apparatus is sensed to be rotated to the left by 90°.

A stereo audio signal is divided into a left audio signal and a right audio signal (S1620). At this time, a sub-woofer audio signal, which is of a low audio frequency commonly included in the left audio signal and the right audio signal (for example, 20 Hz to 1.5 KHz), may be further separated.

If locations of the speakers are changed due to the rotation of the electronic apparatus, audio signals corresponding to the changed locations are provided to the plurality of speakers disposed away from one another on the main body of the electronic apparatus (S1630). The operation of providing the audio signals to the plurality of speakers according to the changed locations of the speakers has been described above with reference to FIGS. 2 to 13 and thus an overlapped explanation is omitted.

Accordingly, the method for providing the stereo sound according to the exemplary embodiments can provide the stereo sound of proper directionality, even if the locations of the speakers are changed due to the rotation of the electronic apparatus. The method for providing the stereo sound of FIG. 16 may be implemented by the electronic apparatus of FIG. 1 or may be implemented by any other electronic apparatus.

Also, the method for providing the stereo sound described above may be realized by at least one execution program to execute the method for providing the stereo sound and the execution program may be stored in a computer readable recording medium.

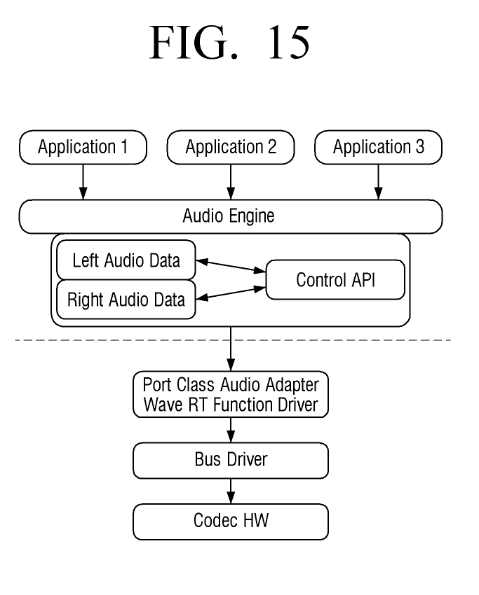

FIG. 17 illustrates an electronic apparatus according to an exemplary embodiment of the present general inventive concept.

The electronic apparatus 1700 illustrated in FIG. 17 includes a sensor 1710, a camera 1720, an image processor 1730, a controller 1740, an audio processor 1750, and speakers 1760.

The sensor 1710 senses an orientation of the electronic apparatus 1700. The sensor 1710 may sense when the electronic apparatus 1700 is rotated to the left or right between portrait and landscape orientations. The sensor may include a geomagnetic sensor, a gyro sensor, an acceleration sensor, or a gyro/acceleration sensor. The sensor 1710 may output the sensed orientation of the electronic apparatus 1700 to the controller 1740.

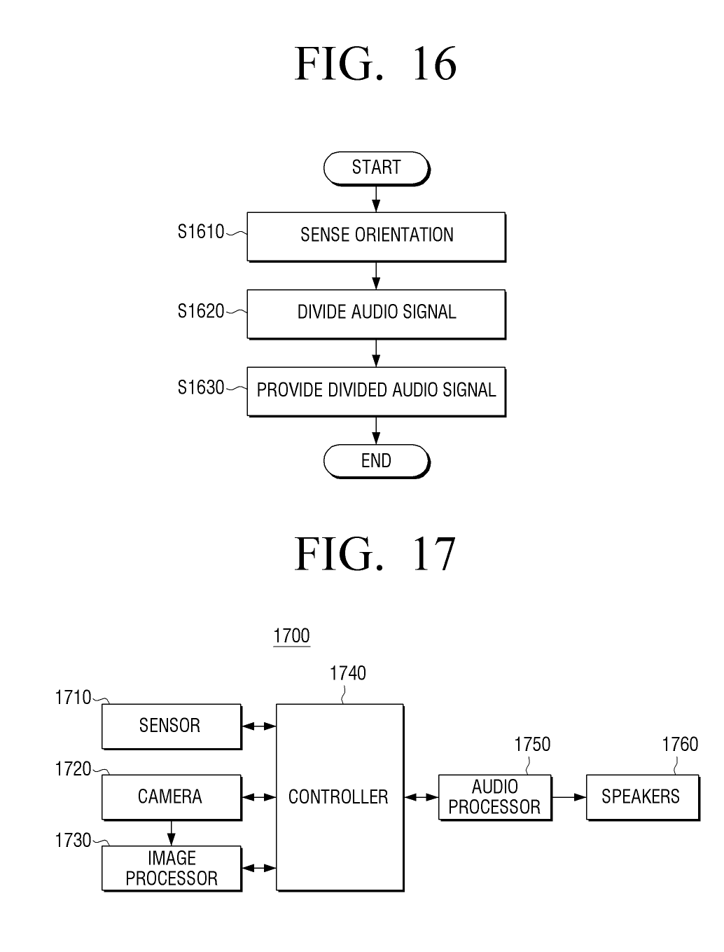

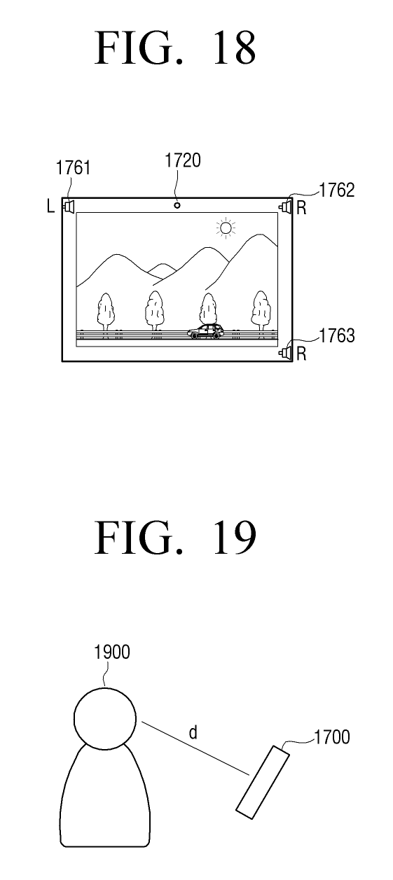

The camera 1720 captures images. The camera 1720 may be located on a front side of the electronic apparatus 1700 as illustrated in FIG. 18. When the camera 1720 is located on the front side of the electronic apparatus 1700, it may be used to capture an image of a user 1900 operating the electronic apparatus 1700 as illustrated in FIG. 19. The camera 1720 may output the captured image to the image processor 1730 for processing.

The image processor 1730 processes images captured by the camera 1720. For instance, the image processor 1730 may process an image to locate a user in the captured image. The image processor 1730 may also process the image to locate the head of the user in the captured image. The image processor 1730 may output the processed image to the controller 1740 to be used to determine the orientation of the electronic apparatus 1700 with respect to the user 1900 and/or to determine the locations of the speakers 1760 with respect to the user 1900.

The audio processor 1750 receives an audio signal from the controller 1740, processes the audio signal, and outputs processed audio signals to the speakers 1760. For instance, the audio processor may process the audio signal based on the location of the speakers 1760 with respect to the user 1900. For example, when one speaker is oriented on the left side of the electronic apparatus 1700 with respect to the user 1900, the audio processor 1750 may output a left audio signal to the speaker and when the orientation of the electronic apparatus 1700 changes such that the speaker is on the right side of the electronic apparatus 1700 with respect to the user, the audio processor 1750 may output a right audio signal to the speaker. As such, when the audio signal is a stereo audio signal, the left and right audio signals may be output to the proper speakers with respect to the user.

Additionally, the audio processor 1750 may process the audio signal into virtual surround audio signals based on the locations of the speakers 1760 with respect to the user 1900. That is, the audio processor 1750 may output processed audio signals to the speakers 1760 such that the speakers 1760 output sound that simulates a surround sound for the user 1900. The audio processor 1750 is able to create high quality virtual surround audio signals because it has information on the location of the speakers 1760 with respect to the user.

The speakers 1760 receive processed audio signals from the audio processor 1750 and output sounds. The speakers 1760 may be disposed at different locations on the electronic apparatus 1700. Although FIG. 18 illustrates three speakers 1761, 1762, and 1763, the present general inventive concept is not limited thereto. The electronic apparatus 1700 may include less than three or more than three speakers.

The controller 1740 determines the location of the speakers 1760 with respect to the user 1900. The controller 1740 may use the sensed orientation from the sensor 1710 to determine the location of the speakers 1760. The controller 1740 may also use the image of the user to determine the location of the speakers 1760 with respect to the user 1900. That is, the sensor 1710 may sense the orientation of the electronic apparatus 1700 and the controller 1740 may use the image of the user to determine the distance of the user from the electronic apparatus 1700 to provide an accurate location of the speakers 1760 with respect to the user.

The controller 1740 may also determine the location of the speakers 1760 with respect to the user 1900 by using only the image of the user. That is, the image of the user may be processed to determine the orientation of the user with respect to the electronic apparatus. As an example, features of the user's face may be recognized from the image of the user to determine the orientation of the user with respect to the electronic apparatus 1700. Also, the distance of the user from the electronic apparatus may be determined from the image of the user. The controller 1740 may also determine the location of the speakers 1760 with respect to the head of the user 1900 to more accurately create a virtual surround sound.

The controller 1740 also controls the audio processor 1750 to process the audio signal based on the location of the speakers 1760 with respect to the user 1900.

FIG. 18 illustrates a front view of the electronic apparatus 1700.

Referring to FIG. 18, the electronic apparatus 1700 includes a camera 1720 and speakers 1761, 1762, and 1763. The present general inventive concept is not limited to the three speakers 1761, 1762, 1763, but may include any number of speakers. Also, while the speakers 1761, 1762, and 1763 are located in corners of the electronic apparatus 1700, the present general inventive concept is not limited thereto and the speakers may be located at various locations on the electronic apparatus 1700. While FIG. 18 illustrates one camera 1720, the present general inventive concept is not limited thereto and may include any number of cameras. for example, the electronic apparatus 1700 may include two cameras and may use a comparison of images captured by the cameras to more accurately determine a distance of the user from the electronic apparatus.

FIG. 19 illustrates the user 1900 and the electronic apparatus 1700. As illustrated in FIG. 19, the electronic apparatus 1700 may be located a distance d from the user 1900. An image of the user captured by the camera 1720 may be used to determine the distance d.

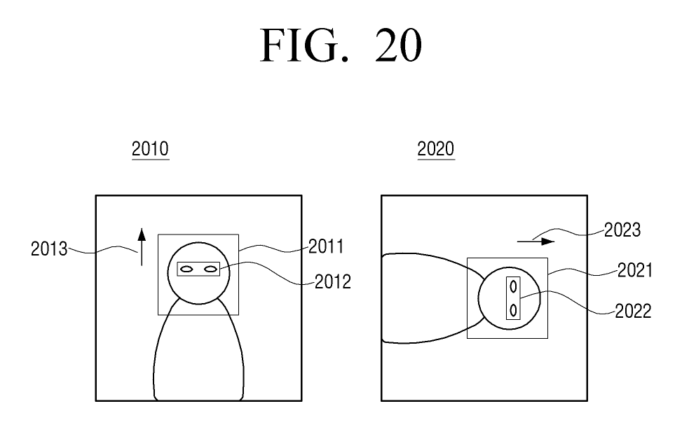

FIG. 20 illustrates images of the user captured by the camera 1720. The first image 2010 is an image that is captured when the electronic apparatus 1700 is oriented in the same direction as the user. The user's head 2011 may be located in the image through image processing such as facial recognition. Also, the orientation of the user 2013 with respect to the electronic apparatus 1700 may be determined from the image. For example, features of the user such as eyes 2012 may be recognized to determine the orientation of the user from the image. The second image 2020 is an image captured when the user is oriented in a different direction than the electronic apparatus 1700. The orientation of the user 2023 is rotated 90° with respect to the electronic apparatus 1700. The user's head 2021 and features of the user such as eyes 2022 may be located in the second image 2020 as described above with respect to the first image 2010.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. An electronic apparatus comprising:
a sensor to sense an orientation of the electronic apparatus;
an audio processor to divide a stereo audio signal into a left audio signal and a right audio signal;
a plurality of speakers disposed at separate locations on a main body of the electronic apparatus to output the left audio signal and the right audio signal;
a switching unit to output the left audio signal and the right audio signal from the audio processor to the plurality of speakers; and
a controller to control the switching unit to switch the output of the left audio signal and the right audio signal between the plurality of speakers based on a change in the orientation of the electronic apparatus.

2. The electronic apparatus as claimed in claim 1, wherein the plurality of speakers comprises:
a first speaker and a second speaker disposed in opposite corners on the main body of the electronic apparatus,
wherein the controller controls one of the first and the second speakers that is disposed on a left side of the electronic apparatus according to the orientation of the electronic apparatus to output the left audio signal and the other of the first and the second speakers that is disposed on a right side of the electronic apparatus according to the orientation of the electronic apparatus to output the right audio signal.

3. The electronic apparatus as claimed in claim 1, wherein the audio processor further divides the stereo audio signal into a sub-woofer audio signal.

4. The electronic apparatus as claimed in claim 3, wherein the plurality of speakers comprises:
a first speaker, a second speaker, and a third speaker disposed in three corners on the main body of the electronic apparatus,
wherein the controller controls one of the first through third speakers that is disposed on a left side of the apparatus according to the orientation of the electronic apparatus to output the left audio signal, one of the first through third speakers that is disposed on a right side of the electronic apparatus according to the orientation of the electronic apparatus to output the right audio signal, and the remaining speaker of the first through third speakers to output the sub-woofer audio signal.

5. The electronic apparatus as claimed in claim 1, wherein the plurality of speakers comprises:
a first speaker, a second speaker, a third speaker, and a fourth speaker disposed in four corners on the main body of the electronic apparatus,
wherein the controller controls two of the first through the fourth speakers that are disposed on a left side of the electronic apparatus according to the orientation of the electronic apparatus to output the left audio signal and two speakers of the first through fourth speakers that are disposed on a right side of the electronic apparatus according to the orientation of the electronic apparatus to output the right audio signal.

6. The electronic apparatus as claimed in claim 1, wherein the plurality of speakers comprises:
a first speaker disposed on a left side of the main body of the electronic apparatus; and
a second speaker disposed on a right side of the main body of the electronic apparatus,
wherein, if the orientation of the electronic apparatus is a first landscape orientation with reference to a user, the controller controls the first speaker to output the left audio signal and the second speaker to output the right audio signal, and, if the orientation of the electronic apparatus is a second landscape orientation which is rotated by 180° from the first landscape orientation, the controller controls the first speaker to output the right audio signal and the second speaker to output the left audio signal.

7. The electronic apparatus as claimed in claim 1, further comprising:
a user interface to display a user interface window,
wherein the sensor senses the orientation of the electronic apparatus according to a display direction of the user interface window on the main body of the electronic apparatus.

8. The electronic apparatus as claimed in claim 1, wherein the sensor senses the orientation of the electronic apparatus using at least one of a geomagnetic sensor, a gyro sensor, an acceleration sensor, and a gyro/acceleration sensor.

9. A method of providing a stereo sound of an electronic apparatus, the method comprising:
sensing an orientation of the electronic apparatus;
dividing a stereo audio signal into a left audio signal and a right audio signal;
outputting the left audio signal and the right audio signal to a plurality of speakers; and
controlling the outputting of the left audio signal and the right audio signal by switching the output of the left audio signal and the right audio signal between the plurality of speakers based on a change in the orientation of the electronic apparatus.

10. The method as claimed in claim 9, wherein the plurality of speakers include a first speaker and a second speaker disposed in opposite corners on the main body of the electronic apparatus,
wherein the controlling the outputting of the left audio signal and the right audio signal comprises controlling one of the first and the second speakers that is disposed on a left side of the electronic apparatus according to the orientation of the electronic apparatus to output the left audio signal and the other of the first and second speakers that is disposed on a right side of the electronic apparatus according to the orientation of the electronic apparatus to output the right audio signal.

11. The method as claimed in claim 9, wherein the dividing comprises further dividing the stereo audio signal into a sub-woofer audio signal.

12. The method as claimed in claim 11, wherein the plurality of speakers include a first speaker, a second speaker, and a third speaker disposed in three corners on the main body of the electronic apparatus,
wherein the controlling the outputting of the left audio signal and the right audio signal comprises controlling one of the first through third speakers that is disposed on a left side of the apparatus according to the orientation of the electronic apparatus to output the left audio signal, one of the first through third speakers that is disposed on a right side of the electronic apparatus according to the orientation of the electronic apparatus to output the right audio signal, and the remaining speaker of the first through third speakers to output the sub-woofer audio signal.

13. The method as claimed in claim 9, wherein the plurality of speakers include a first speaker, a second speaker, a third speaker, and a fourth speaker disposed in four corners on the main body of the electronic apparatus,
wherein the controlling the outputting of the left audio signal and the right audio signal comprises controlling two speakers of the first through fourth speakers that are disposed on a left side of the electronic apparatus according to the orientation of the electronic apparatus to output the left audio signal and two speakers of the first through fourth speakers that are disposed on a right side of the electronic apparatus to output the right audio signal.

14. The method as claimed in claim 9, wherein the plurality of speakers comprise:
a first speaker disposed on a left side of the main body of the electronic apparatus; and
a second speaker disposed on a right side of the main body of the electronic apparatus,
wherein controlling the outputting of the left audio signal and the right audio signal comprises, if the orientation of the electronic apparatus is a first landscape orientation with reference to a user, controlling the first speaker to output the left audio signal and the second speaker to output the right audio signal, and if the orientation of the electronic apparatus is a second landscape orientation which is rotated by 180° from the first landscape orientation, controlling the first speaker to output the right audio signal and the second speaker to output the left audio signal.

15. The method as claimed in claim 9, further comprising displaying a user interface window,
wherein the sensing comprises sensing the orientation of the electronic apparatus according to a display direction of the user interface window on the main body of the electronic apparatus.

16. The method as claimed in claim 9, wherein the sensing comprises sensing the orientation of the electronic apparatus using at least one of a geomagnetic sensor, a gyro sensor, an acceleration sensor, and a gyro/acceleration sensor.

17. A non-transitory computer readable recording medium comprising a program to execute a method of providing a stereo sound, the method comprising:
sensing an orientation of an electronic apparatus;
dividing a stereo audio signal into a left audio signal and a right audio signal;
outputting the left audio signal and the right audio signal to a plurality of speakers; and
controlling the outputting of the left audio signal and the right audio signal by switching the output of the left audio signal and the right audio signal between the plurality of signals based on a change in the orientation of the electronic apparatus.

18. The electronic apparatus of independent claim 1, wherein the electronic apparatus is at least one of a tablet computer and a mobile phone.

19. An electronic apparatus comprising:
a sensor to sense an orientation of the electronic apparatus with respect to a user;
a plurality of speakers disposed at different locations on the electronic apparatus;
a switching unit to output a left audio signal and a right audio signal to the plurality of speakers; and
a controller to control the switching unit to switch the output of the left and right audio signals to the plurality of speakers when the orientation of the electronic apparatus changes such that the switching unit outputs the left audio signal to one or more of the plurality of speakers oriented on a left side of the electronic apparatus with respect to the user and outputs the right audio signal to one or more of the plurality of speakers oriented on a right side of the electronic apparatus with respect to the user.

20. An electronic apparatus comprising:
a sensor to sense an orientation of the electronic apparatus with respect to a user;
a plurality of speakers disposed at different locations on the electronic apparatus;
an audio processor to process an audio signal and to output processed audio signals to each of the plurality of speakers; and
a controller to determine a location of each of the plurality of speakers with respect to the user based on the sensed orientation and to control the audio processor to process the audio signal based on the determined locations of each of the plurality of speakers.

21. The electronic apparatus of claim 20, wherein the audio processor processes the audio signal into virtual surround sound signals based on the determined locations of each of the plurality of speakers.

22. The electronic apparatus of claim 20, wherein the controller determines the location of each of the plurality of speakers with respect to a head of the user.

23. The electronic apparatus of claim 20, further comprising:
a camera disposed on a front side of the electronic apparatus; and
an image processor to image process images captured by the camera.

24. The electronic apparatus of claim 23, wherein the camera captures an image of the user, the image processor processes the captured image to locate the user in the captured image, and the controller determines the location of each of the plurality of speakers with respect to the user by using the processed image.

25. The electronic apparatus of claim 24, wherein the image processor processes the captured image to locate a head of the use in the captured image and the controller determine the location of each of the plurality of speakers with respect to the head of the user.

26. The electronic apparatus of claim 25, wherein the image processor uses facial recognition processing to locate the head of the user in the captured image.

27. An electronic apparatus comprising:
a camera disposed on a front side of the electronic apparatus to capture an image of a user;
an image processor to process the captured image to locate the user in the captured image;
a plurality of speakers disposed at different locations on the electronic apparatus;
an audio processor to process an audio signal and to output processed audio signals to each of the plurality of speakers; and
a controller to determine a location of each of the plurality of speakers with respect to the user by using the processed image and to control the audio processor to process the audio signal based on the determined locations of each of the plurality of speakers.
